(19) United States
(12) Patent Application Publication
(10) Pub. No.: US 2020/0383870 A1
(43) Pub. Date: Dec. 10, 2020

(54) CONTINUOUS ROTARY MACHINE AND RELATIVE METHOD FOR FILLING CAPSULES WITH PHARMACEUTICAL OR NUTRACEUTICAL PRODUCTS

(71) Applicant: MG2 - S.R.L, Pianoro (IT)

(72) Inventor: Ernesto GAMBERINI, RASTIGNANO (IT)

(21) Appl. No.: 16/891,251

(22) Filed: Jun. 3, 2020

(30) Foreign Application Priority Data
Jun. 5, 2019 (IT) 102019000008136

(51) Int. Cl. A61J 3/07

(52) U.S. Cl. CPC A61J 3/074

(57) ABSTRACT

A continuous rotary machine for filling capsules with pharmaceutical or nutraceutical products is provided with a hopper to contain a pharmaceutical or nutraceutical product in powder delimited by a bottom wall having a plurality of dosing chambers, each of which is fed along a ring-shaped path, and cooperates with a compacting piston movable along the dosing chamber in order to compact the product along a first segment of the ring-shaped path and to discharge only part of the product inside a corresponding capsule along a second segment of the ring-shaped path.

### CROSS-REFERENCE TO RELATED APPLICATIONS

This patent application claims priority from Italian patent application no. 102019000008136 filed on Jun. 5, 2019, the entire disclosure of which is incorporated herein by reference.

### TECHNICAL FIELD

This invention relates to a continuous rotary machine for filling capsules with pharmaceutical or nutraceutical products.

### BACKGROUND OF THE INVENTION

In the field of pharmaceutical or nutraceutical powder products packaging, it is well known to provide a continuous rotary machine of the type comprising a pocket conveyor, which is continuously movable along a given path, and is equipped with a plurality of pockets that are each designed to receive a corresponding bottom of a corresponding capsule; a container for a pharmaceutical or nutraceutical product mounted in order to continuously rotate about a first rotation axis; and a dosing wheel mounted to continuously rotate about a second rotation axis that is eccentric to the first rotation axis.

The dosing wheel is equipped with at least one dosing device, which comprises a cylinder and a piston axially movable under the thrust of an operating device, and is fed by the dosing wheel through, first of all, a station for collecting a given quantity of product from the container and then along a portion of the above-mentioned path in phase with a corresponding pocket for transferring the product into the corresponding bottom.

At the collecting station, the cylinder and the piston are, first of all, moved in relation to each other so as to define a dosing chamber of a given volume. They are then moved with the same law of motion inside the container so as to fill the dosing chamber with the product. They are then moved in relation to each other to enable the piston to compact the product contained inside the dosing chamber, and are finally moved with the same law of motion outside the container.

Once outside the container, the dosing device is lowered onto the pocket conveyor to transfer the product to the corresponding bottom.

Known continuous rotary machines of the type described above, although super-tested, have some drawbacks that are mainly due to the fact that the disengagement of the dosing device from the container entails both dragging the product outside the container and losing some product from the dosing chamber.

In addition, known continuous rotary machines of the type described above are relatively complex and costly.

### SUMMARY OF THE INVENTION

The purpose of this invention is to provide a continuous rotary machine for filling capsules with pharmaceutical or nutraceutical products, which is free from the drawbacks described above and simple and inexpensive to implement.

According to this invention, a continuous rotary machine for filling capsules with pharmaceutical or nutraceutical products is provided as claimed in the claims from 1 to 11.

This invention further relates to a method for filling capsules with pharmaceutical or nutraceutical products.

According to this invention, a method for filling capsules with pharmaceutical or nutraceutical products is provided as claimed in the claims from 12 to 15.

### BRIEF DESCRIPTION OF THE DRAWINGS

This invention will now be described with reference to the accompanying drawings, which illustrate a non-limiting embodiment thereof, wherein:

FIG. 1 is a schematic plan view, with parts removed for clarity, of a preferred embodiment of the machine of this invention;

FIG. 2 is a schematic side view, with parts in cross-section and parts removed for clarity, of a detail of the machine in FIG. 1;

FIG. 3 schematically illustrates the operating principle of the machine in FIG. 1; and

FIG. 4 is a schematic plan view, with parts removed for clarity, of a variant of the machine in FIG. 1.

### DETAILED DESCRIPTION OF THE INVENTION

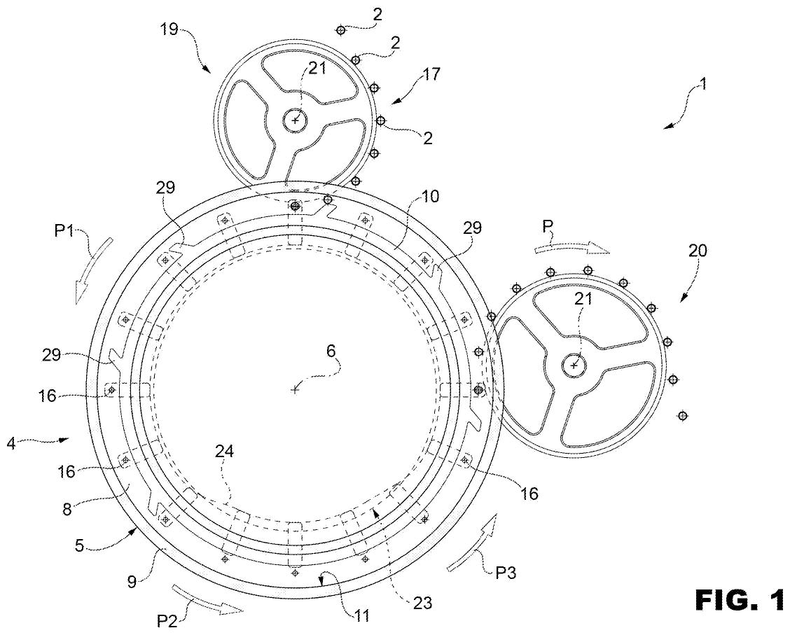

With reference to FIGS. 1 to 3, the number 1 indicates, as a whole, a continuous rotary machine for filling capsules (not illustrated) with pharmaceutical or nutraceutical products.

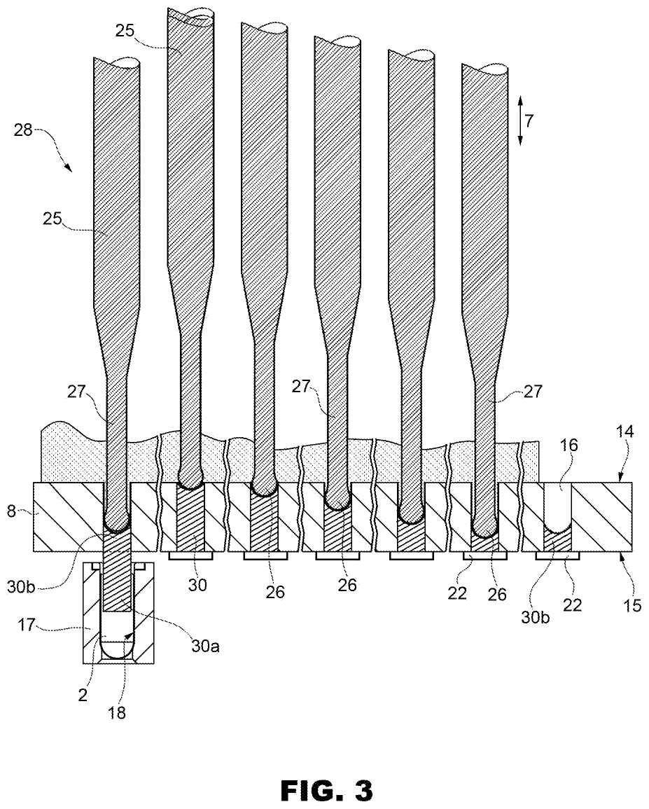

Each capsule (not illustrated) comprises a bottom 2 (FIG. 3) and a lid (not illustrated) for closing the bottom 2.

The machine 1 comprises a frame 3 and a dosing wheel 4 comprising, in turn, a hopper 5 for containing a pharmaceutical or nutraceutical product.

The hopper 5 has a cup shape with a concavity facing upwards, and is mounted to continuously rotate in relation to the frame 3 and under the thrust of a known and not illustrated operating device about a rotation axis 6 that is parallel to a substantially vertical direction 7.

The hopper 5 is delimited by a substantially flat bottom wall 8 that is perpendicular to the axis 6, and is also delimited by a side wall 9 extending about the axis 6.

The wheel 4 also comprises a distribution plate 10, which is mounted inside the hopper 5 coaxially to the axis 6, is fixed to the frame 3, and has a cup shape with a concavity facing downwards.

The hopper 5 and the plate 10 are substantially hermetically coupled together in order to define an annular containment chamber 11, which is coaxial to the axis 6, is closed at the top by an annular lid 12 fixed to the wall 9, and is supplied with the pharmaceutical or nutraceutical product through a supply duct 13 mounted through the plate 10 itself.

The wall 8 is axially delimited by an upper face 14 and a lower face 15 opposite each other, and is provided with a plurality of dosing chambers 16, which are uniformly distributed about the axis 6, extending between the faces 14 and 15, and are formed at the chamber 11.

Each chamber 16 extends parallel to the direction 7, and has a volume equal to the product between its crosssection and a thickness of the wall 8.

The machine 1 also comprises a pocket conveyor 17 provided with a plurality of pockets 18 configured to each house on the inside a corresponding bottom 2.

The pockets 18 are fed by the conveyor 17 along a ring-shaped path P (only partially illustrated in FIG. 1), and are distributed along the conveyor 17 itself with a distribution pitch substantially equal to a distribution pitch of the chambers 16 about the axis 6.

The conveyor 17 extends about a wheel 19 at the entrance of the bottoms 2 in the wheel 4, under the hopper 5, and about a wheel 20 at the outlet of the bottoms 2 from the wheel 4.

The wheels 19, 20 are mounted in order to rotate, in relation to the frame 3 and under the thrust of a known and not illustrated operating device, about respective rotation axes 21 parallel to the axis 6.

Each chamber 16 is closed at the bottom by a shutter 22, which extends under the wall 8, is fed by the hopper 5 about the axis 6, and is coupled in a sliding manner to the wall 8 to make radial movements transverse to the axis 6 in relation to the hopper 5 between a closing position, wherein the shutter 22 is located below the chamber 16, and an opening position, wherein the shutter 22 disengages the chamber 16.

The shutters 22 are moved between the corresponding closing and opening positions by a cam operating device 23 comprising an annular cam 24 fixed to the frame 3 about the axis 6 and, for each shutter 22, a corresponding tappet (not illustrated) engaged in the cam 24.

Each chamber 16 also cooperates with a compacting piston 25, which extends through the lid 12, and is coupled in a sliding manner to the hopper 5 in order to carry out, in relation to the hopper 5 and under the thrust of a cam operating device (not illustrated), straight movements in the direction 7.

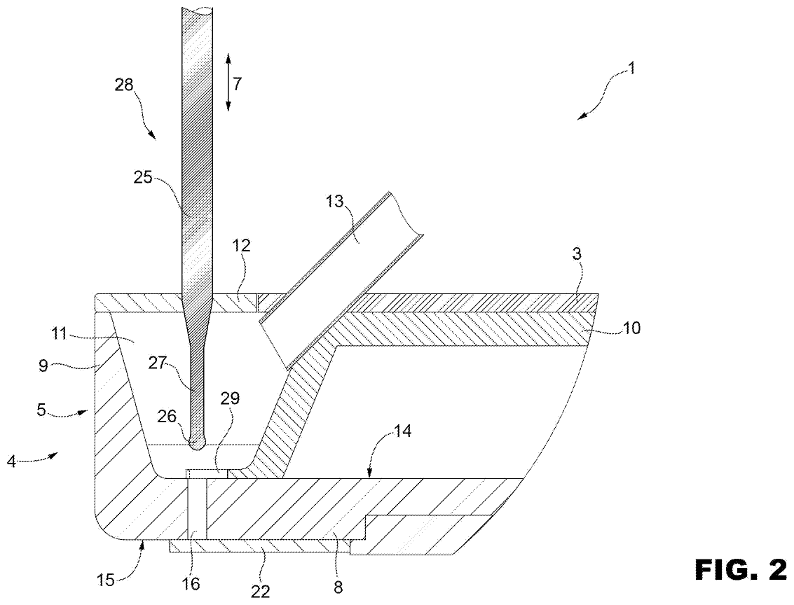

The cam operating device (not illustrated) comprises a cam extending about the axis 6 and, for each piston 25, a respective tappet engaged in the cam itself, and configured to selectively move each piston 25 between a raised rest position (FIGS. 2 and 3), wherein the piston 25 is arranged outside chamber 16, and a lowered operating position (FIG. 3), wherein the piston 25 extends inside the chamber 16.

The piston 25 has a cylindrical shape, and is provided with an end head 26 with a spherical shape, which is designed to come into contact with the product, and protrudes from a shank 27 having a diameter smaller than a diameter of the head 26.

According to some variants not illustrated, the head 26 has shapes other than the spherical shape.

Each chamber 16, the corresponding shutter 22, and the corresponding piston 25 define a dosing device 28, which is fed by the hopper 5 about the axis 6 and along a ring-shaped path comprising a first segment P1, at which the shutter 22 is arranged in its closing position to enable the piston 25 to compact the product contained in the chamber 16, a second segment P2, at which the shutter 22 is arranged in its opening position to enable the piston 25 to discharge the product contained in the chamber 16 into the corresponding bottom 2, and a third segment P3, at which the shutter 22 is moved back into its closing position.

With regard to the above, it should be pointed out that the distribution plate 10 is provided with a plurality of distribution vanes 29, which protrude outwards from the plate 10, are distributed about the axis 6 along the segment P1, and are alternately tilted, one in the feeding direction of the hopper 5 about the axis 6 and the other in the direction opposite to the feeding direction of the hopper 5 about the same axis 6, to ensure the product is correctly distributed in the chamber 11.

The operation of the machine 1 will now be described with reference to FIG. 3, imagining the filling of just one bottom 2, and beginning from a point at which the corresponding shutter 22 is arranged in its closing position and the corresponding piston 25 is arranged in the raised rest position in order to enable the product to fall from the chamber 11 into the corresponding chamber 16.

As the dosing device 28 is fed along the segment P1, the shutter 22 is held in its closing position and the piston 25 is alternately moved in the direction 7 between its lowered operating position, wherein the piston 25 compacts the product contained in the chamber 16, and its raised rest position, wherein the piston 25 enables new product to fall from the chamber 11 into the chamber 16.

At the entrance of the segment P2, the chamber 16 houses a product dose 30 on the inside.

In this respect, it should be noted that, as well known, because of the alternate raising and lowering of the piston 25, the product is compacted inside the chamber 16 and against the shutter 22. In other words, when the shutter 22 is opened, the dose 30 disengages the chamber 16 but only when pushed outside the chamber 16 by the piston 25.

As the dosing device 28 is fed along the segment P2, the shutter 22 is moved in its opening position and the piston 25 is lowered inside the chamber 16 in order to discharge the product into the bottom 2.

In this respect, it should be noted that the movement of the piston 25 along the chamber 16 in the direction 7 is selectively controlled at the segment P2 so as to:

stop the piston 25 at a given distance from the lower face 15 of the wall 8; and

enable the piston 25 to discharge just a first portion 30a of the dose 30 contained in the chamber 16 into the bottom 2 and to hold a second portion 30b of the dose 30 in the chamber 16.

Since, as already described above, the product of the dose 30 is compacted inside the chamber 16: the stopping of the piston 25 at a given distance from the lower face 15 of the wall 8 enables the discharge of just the portion 30a into the bottom 2; and

the portion 30b closes the chamber 16 at the bottom so as to prevent the product escaping the chamber 16.

In this case, the axial position of the pistons 25 along the segment P2 and, thus, the portions 30a discharged into the bottoms 2, are selectively controlled by modifying the position of a segment of the cam of the cam operating device (not illustrated) of the pistons 25 in the direction 7 and at the segment P2.

According to a variant not illustrated, the axial position of the pistons 25 along the segment P2 and, thus, the portions 30a discharged into the bottoms 2, are selectively controlled by means of an adjustment device configured to adjust the position of each piston 25 in relation to the cam of the cam operating device (not illustrated).

According to another variant not illustrated, the cam operating device (not illustrated) is eliminated and replaced by an operating device comprising, for each piston 25, a corresponding operating motor.

As the device 28 is fed along the segment P3, the shutter 22 is moved back from its opening position into the closing position so as to separate the portion 30a from the portion 30b and so as to close the chamber 16 at the bottom.

The machine 1 has some advantages mainly due to the fact that:

the portion 30a of the dose 30 supplied inside each bottom 2 is selectively controlled in a relatively simple and cost-effective manner by selectively controlling the position of the corresponding piston 25 along the corresponding chamber 16;

each portion 30a is supplied directly from the chamber 11 into the corresponding bottom 2 through the corresponding chamber 16;

the chamber 11 is substantially coupled in a fluid-tight manner to the outside environment; and

the portions 30b prevent the product leaking between the wall 8 and the shutters 22 from being dispersed into the outside environment.

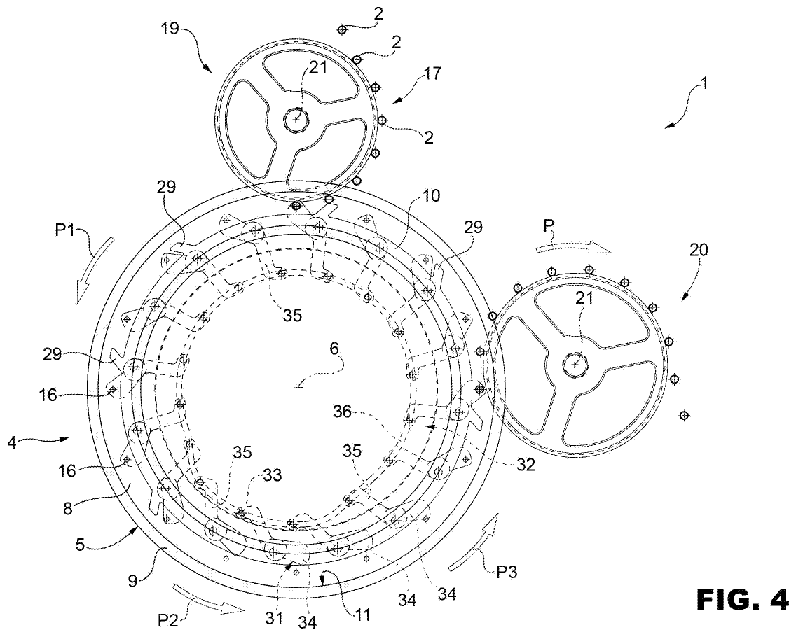

The variant illustrated in FIG. 4 differs from what is illustrated in the preceding figures solely in that, therein, the shutters 22 are eliminated and replaced by corresponding rocker arms 31 and the cam operating device 23 is eliminated and replaced by another cam operating device 32.

Each rocker arm 31 is hinged to the lower face 15 of the wall 8 to rotate, in relation to the hopper 5, about a fulcrum axis 33 that is parallel to the axis 6, and has a first arm 34 movable between a closing position and an opening position of the corresponding chamber 16 and a second arm 35 provided with a tappet (not illustrated) engaged in a cam 36 of the device 32.

The operation of the rocker arms 31 is totally similar to that of the shutters 22.

According to a variant not illustrated, the portions 30a and 30b are separated from each other by means of a blade fixed to the frame 3.

1. A continuous rotary machine for filling capsules with pharmaceutical or nutraceutical products, each capsule comprising a bottom (2) and a lid to close the bottom (2); the machine comprising a hopper (5), which houses, on the inside, a pharmaceutical or nutraceutical product in powder, is mounted so as to continuously rotate around a substantially vertical rotation axis (6) and is delimited by a bottom wall (8); and a pocket conveyor (17) provided with a plurality of pockets (18), each feeding a relative bottom (2) around the rotation axis (6); and being characterised in that:
the bottom wall (8) is provided with a plurality of dosing chambers (16), which are formed through the bottom wall (8) and are fed by the hopper (5) along a ring-shaped path extending about the rotation axis (6);
the pocket conveyor (17) extends under the hopper (5) so as to feed each pocket (18) in phase with a relative dosing chamber (16); and
the machine further comprises closing means (22; 31) configured to close the dosing chambers (16) at the bottom along a first segment (P1) of the ring-shaped path and to open the dosing chambers (16) at the bottom along a second segment (P2) of the ring-shaped path; for each dosing chamber (16), a respective compacting piston (25) mounted on the hopper (5) and movable along the dosing chamber (16) parallel to the rotation axis (6) in order to compact the product along the first segment (P1) and discharge the product into the relative bottom (2) along the second segment (P2); and an operating device to move the compacting pistons (25) parallel to the rotation axis (6); the operating device being configured to selectively control the position of the compacting pistons (25) along the relative dosing chambers (16) so that, along the second segment (P2), each compacting piston (25) is moved along part of the corresponding dosing chamber (16) and discharges only part of the product contained in the relative dosing chamber (16) into the relative bottom (2).

2. A machine according to claim 1, wherein the operating device comprises a cam extending about the rotation axis (6) and, for each compacting piston (25), a respective tappet engaged in the cam; the cam comprising an adjustable portion mounted near the second segment (P2) and movable along the rotation axis (6) in order to change the axial position of each compacting piston (25) along the second segment (P2) and selectively control the quantity of product discharged into the relative bottom (2).

3. A machine according to claim 1, wherein the operating device comprises a cam extending about the rotation axis (6) and, for each compacting piston (25), a respective tappet engaged in the cam and a respective adjustment device to change the axial position of the compacting piston (25) relative to the tappet and, hence, the quantity of product discharged into the relative bottom (2).

4. A machine according to claim 1, wherein the operating device comprises, for each compacting piston (25), a respective operating motor to change the axial position of the compacting piston (25) along the second segment (P2) and selectively control the quantity of product discharged into the relative bottom (2).

5. A machine according to claim 1, wherein each compacting piston (25) is movable between a lifted position, in which the compacting piston (25) disengages the relative dosing chamber (16), and a lowered position, in which the compacting piston (25) moves only inside part of the dosing chamber (16).

6. A machine according to claim 1, wherein the dosing chambers (16) extend between an upper face (14) and a lower face (15) of the bottom wall (8).

7. A machine according to claim 1, wherein the closing means (22; 31) comprise, for each dosing chamber (16), a respective shutter mounted on the hopper (5) under the bottom wall (8) so as to move between an opening position and a closing position of the dosing chamber (16).

8. A machine according to claim 7, wherein the ring-shaped path further comprises a third segment (P3) formed downstream of the second segment (P2) in a feeding direction of the hopper (5) about the rotation axis (6); each shutter being movable along the third segment (P3) from the opening position to the closing position so as to separate a first product portion (30a) designed to be supplied into the relative bottom (2) from a second product portion (30b) designed to be held in the dosing chamber (16).

9. A machine according to claim 7, wherein each shutter (22) is coupled to the hopper (5) in a sliding manner so as to radially move, relative to the hopper (5), between its opening and closing positions.

10. A machine according to claim 7, wherein each shutter (31) is coupled to the hopper (5) in a rotary manner so as to rotate, relative to the hopper (5), between its opening and closing positions.

11. A machine according to claim 1, wherein each compacting piston (25) has an end head (26) with a substantially spherical shape, which is designed to come into contact with the product.

12. A method for filling capsules with pharmaceutical or nutraceutical products in a continuous rotary machine comprising a hopper (5), which houses, on the inside, a pharmaceutical or nutraceutical product in powder, is mounted so as to continuously rotate about a substantially vertical rotation axis (6), is delimited by a bottom wall (8) and is provided with a plurality of dosing chambers (16), which are formed through the bottom wall (8) and are fed by the hopper (5) along a ring-shaped path extending about the rotation axis (6); closing means (22; 31) configured to close the dosing chambers (16) at the bottom along a first segment (P1) of the ring-shaped path and to open the dosing chambers (16) at the bottom along a second segment (P2) of the ring-shaped path; a pocket conveyor (17) provided with a plurality of pockets (18), each feeding a relative bottom (2) about the axis (6), under the hopper (5), and in phase with a relative dosing chamber (16); and, for each dosing chamber (16), a respective compacting piston (25) mounted on the hopper (5) and movable along the dosing chamber (16) parallel to the rotation axis (6);
the method being characterised in that it comprises the steps of:
along the first segment (P1) of the ring-shaped path, moving each compacting piston (25) along the relative dosing chamber (16) so as to compact the product contained in the dosing chamber (16); and
along the second segment (P2) of the ring-shaped path, moving each compacting piston (25) along part of the relative dosing chamber (16) so as to discharge only part of the product contained in the dosing chamber (16) into the relative bottom (2).

13. A method according to claim 12, wherein each dosing chamber (16) houses, on the inside, along the second segment (P2) of the ring-shaped path, a first and a second product portion (30a, 30b); each compacting piston (25) being moved along part of the relative dosing chamber (16) so as to discharge the first portion (30a) into the relative bottom (2) and hold the second portion (30b) in the dosing chamber (16).

14. A method according to claim 13 and further comprising the step of:
adjusting an initial position of each compacting piston (25) relative to the bottom wall (8) so as to selectively control the first product portion (30a) discharged into the relative bottom (2).

15. A method according to claim 13, wherein the closing means (22; 31) comprise, for each dosing chamber (16), a respective shutter mounted on the hopper (5) under the bottom wall (8) so as to move between an opening position and a closing position of the dosing chamber (16); the method further comprising the steps of:
feeding the dosing chambers (16) along a third portion (P3) of the ring-shaped path formed downstream of the second portion (P2) in a feeding direction of the hopper (5) about the rotation axis (6); and
along the third portion (P3) of the ring-shaped path, moving each shutter from its opening position to its closing position so as to separate the relative first portion (30a) from the relative second portion (30b).
